(19) United States
(12) Patent Application Publication
(10) Pub. No.: US 2025/0310805 A1
(43) Pub. Date: Oct. 2, 2025

(54) METHOD AND DEVICE FOR SUPPORTING AERIAL UE COMMUNICATION THROUGH CELLULAR NETWORK

(71) Applicant: Samsung Electronics Co., Ltd., Gyeonggi-do (KR)

(72) Inventors: Kyoungmin PARK, Gyeonggi-do (KR); Hyunsuk RYU, Gyeonggi-do (KR); Jaewon LEE, Gyeonggi-do (KR)

(21) Appl. No.: 18/863,055

(22) PCT Filed: May 9, 2023
(86) PCT No.: PCT/KR2023/006261

§ 371 Date: Nov. 5, 2024

(30) Foreign Application Priority Data
May 9, 2022 (KR) 10-2022-0056795
May 31, 2022 (KR) 10-2022-0066491

(51) Int. Cl. H04W 24/10; H04B 7/06; H04W 84/06

(52) U.S. Cl. CPC H04W 24/10; H04B 7/0617; H04W 84/06

(57) ABSTRACT

The present disclosure relates to a 5G or 6G communication system for supporting higher data transmission rates. A method performed by a terminal of a communication system according to an embodiment of the present invention may comprise the steps of: reporting a cell list measurable by the terminal to a network; receiving, from the network, a candidate aerial cell list indicating a list of candidate cells to be measured by the terminal, which is generated on the basis of the measurable cell list; reporting, to the network, link performances measured for cells in the candidate aerial cell list; receiving an aerial cell list which indicates a list of cells to perform vertical beam steering and is generated on the basis of the link performances; and performing aerial communication on the basis of cells included in the aerial cell list.

### TECHNICAL FIELD

The disclosure is a high layer signaling technique for supporting aerial UE communication through a cellular network and a technology about related terminal and base station operations.

### BACKGROUND ART

5G mobile communication technologies define broad frequency bands enabling high transmission rates and new services and can be implemented in both ‘Sub 6 gigahertz (GHz)’ bands such as a 3.5 GHz band, and ‘Above 6 GHz’ millimeter wave (mmWave) bands such as 28 GHz and 39 GHz bands. In addition, it has been considered to implement 6G mobile communication technologies, referred to as Beyond 5G systems, in terahertz (THz) bands such as 95 GHz to 3 THz bands in order to accomplish transmission rates fifty times faster than 5G mobile communication technologies and ultra-low latencies one-tenth of 5G mobile communication technologies. When the development of 5G mobile communication technologies began, in order to support services and to satisfy performance requirements in connection with enhanced Mobile BroadBand (eMBB), Ultra-Reliable Low-Latency Communications (URLLC), and massive Machine-Type Communications (mMTC), there has been ongoing standardization regarding beamforming and massive Multi-Input Multi-Output (MIMO) for mitigating radio-wave path loss and increasing radio-wave transmission distances in mmWave, supporting operating multiple subcarrier spacings for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amounts of data transmission and a polar code for highly reliable transmission of control information, L2 pre-processing, and network slicing for providing a dedicated network to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-Everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR User Equipment (UE) power saving, Non-Terrestrial Network (NTN) which is a UE-satellite direct communication for providing coverage in unreliable communication with terrestrial networks areas, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step RACH for NR). There also has been ongoing standardization in system architecture/service regarding a 5G baseline architecture, such as service based architecture or interface, for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks. Thus, it is expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The disclosure proposes a method capable of more substantial performance improvement in supporting UAM communication via a cellular network, and specifically proposes a signaling technique for differentiating cell deployment for each of terrestrial UE and aerial UE both operating in the same area. In the following description, the aerial UE refers to a user or user terminal having an altitude different from that of existing cellular network users who perform communication with a base station in a flying state, such as a UAV device or a pilot or passenger on board UAM. In contrast, the terrestrial UE refers to a user or user terminal that performs communication on the ground or in a building that is serviced mainly by the existing cellular network.

### DISCLOSURE OF INVENTION

### Technical Problem

The disclosure is intended to support aerial communication, especially, UAM communication, by utilizing a cellular network already implemented to support a terrestrial UE, and is intended to support improved communication performance compared to existing cellular UAV communication.

Specifically, the disclosure is intended to solve the following issues: increased operational complexity of an aerial UE and deterioration of communication performance through frequent handovers caused by the aerial UE detecting a larger number of hearable cells compared to a terrestrial UE; a phenomenon in which the aerial UE causes a large amount of inter-cell interference to the terrestrial UE in the uplink, and a problem in which the aerial UE experiences a large amount of inter-cell interference in the downlink.

### Solution to Problem

According to an embodiment of the disclosure, a method performed by a terminal in a communication system may include reporting a cell list measurable by the terminal to a network; receiving, from the network, a candidate aerial cell list generated based on the measurable cell list and indicating a list of candidate cells to be measured by the terminal; reporting link performance measured for cells in the candidate aerial cell list to the network; receiving an aerial cell list generated based on the link performance and indicating a list of cells to perform vertical beam steering; and performing aerial communication based on cells included in the aerial cell list.

In addition, according to an embodiment of the disclosure, a terminal in a wireless communication system may include a transceiver and a controller configured to report a cell list measurable by the terminal to a network, to receive, from the network, a candidate aerial cell list generated based on the measurable cell list and indicating a list of candidate cells to be measured by the terminal, to report link performance measured for cells in the candidate aerial cell list to the network, to receive an aerial cell list generated based on the link performance and indicating a list of cells to perform vertical beam steering, and to perform aerial communication based on cells included in the aerial cell list.

In addition, according to an embodiment of the disclosure, a method performed by a base station in a communication system may include receiving a cell list measurable by a terminal; generating a candidate aerial cell list indicating a list of candidate cells to be measured by the terminal, based on the measurable cell list; transmitting the candidate aerial cell list to the terminal; receiving link performance measured for cells in the candidate aerial cell list; generating an aerial cell list indicating a list of cells to perform vertical beam steering, based on the link performance, and transmitting the candidate aerial cell list to the terminal.

In addition, according to an embodiment of the disclosure, a base station in a communication system may include a controller configured to receive a cell list measurable by a terminal, to generate a candidate aerial cell list indicating a list of candidate cells to be measured by the terminal, based on the measurable cell list, to transmit the candidate aerial cell list to the terminal, to receive link performance measured for cells in the candidate aerial cell list, to generate an aerial cell list indicating a list of cells to perform vertical beam steering, based on the link performance, and to transmit the candidate aerial cell list to the terminal.

### Advantageous Effects of Invention

According to an embodiment of the disclosure, a network can support cellular aerial communication with much higher performance than existing cellular UAV communication by granting additional operations to a small number of base stations or cells to support aerial communication, and further increase the performance of cellular aerial communication without introducing new network equipment by designing the additional operations to be low-complexity operations that can be performed by existing base stations rather than high-difficulty operations that require the implementation of new high-performance base stations.

The effects obtainable from the disclosure are not limited to those mentioned above, and other effects not mentioned will be clearly understood from the description below by a person having ordinary skill in the art to which the disclosure belongs.

### BRIEF DESCRIPTION OF DRAWINGS

FIG. 1 is a diagram illustrating an overview of a cellular UAM network communicating through a side lobe of an existing cellular network.

FIG. 2 is a diagram illustrating a scheme of composing a candidate aerial cell list according to an embodiment of the disclosure.

FIG. 3 is a diagram illustrating an example of composing a plurality of candidate aerial cell lists according to an embodiment of the disclosure.

FIG. 4 is a diagram illustrating an example of using a vertical beam of an aerial cell not accessed by an aerial UE according to an embodiment of the disclosure.

FIG. 5 is a diagram illustrating the operations of a UE and a network according to an embodiment of the disclosure.

FIG. 6 is a diagram illustrating the structure of a UE according to an embodiment of the disclosure.

FIG. 7 is a diagram illustrating the structure of a base station according to an embodiment of the disclosure.

### MODE FOR THE INVENTION

Hereinafter, embodiments of the disclosure will be described in detail with reference to the accompanying drawings.

In describing embodiments, descriptions of technical contents that are well known in the technical field to which the disclosure pertains and are not directly related to the disclosure will be omitted. This is to more clearly convey the subject matter of the disclosure without obscuring it by omitting unnecessary description.

For the same reason, some elements are exaggerated, omitted, or schematically illustrated in the accompanying drawings. In addition, the depicted size of each element does not fully reflect the actual size. In the drawings, the same or corresponding elements are assigned the same reference numerals.

The advantages and features of the disclosure and the manner of achieving them will become apparent through embodiments described below with reference to the accompanying drawings. The disclosure may be, however, embodied in many different forms and should not be construed as being limited to the embodiments set forth herein. Rather, these embodiments are provided so that the disclosure will be thorough and complete and will fully convey the scope of the disclosure to those skilled in the art. The disclosure is only defined by the scope of the appended claims. Throughout the specification, the same reference numerals refer to the same elements.

It will be understood that each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which are executed via the processor of the computer or other programmable data processing apparatus, generate means for implementing the functions specified in the flowchart block(s) These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block(s).

In addition, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the term ‘unit’ refers to a software element or a hardware element, such as a field programmable gate array (FPGA) or an application specific integrated circuit (ASIC), which performs a predetermined function. However, the term “unit” does not always have a meaning limited to software or hardware. A ‘unit’ may be constructed either to be stored in an addressable storage medium or to execute one or more processors. Therefore, a ‘unit’ includes, for example, software elements, object-oriented software elements, class elements or task elements, processes, functions, properties, procedures, subroutines, segments of a program code, drivers, firmware, micro-codes, circuits, data, database, data structures, tables, arrays, and variables. The functions provided by elements and ‘units’ may be combined into those of a smaller number of elements and ‘units’ or separated into those of a larger number of elements and ‘units’. In addition, the elements and ‘units’ may be implemented to operate one or more central processing units (CPUs) within a device or a secure multimedia card.

In the following description, terms used to identify access nodes, terms referring to network entities, terms referring to messages, terms referring to interfaces between network entities, terms referring to various kinds of identification information, etc. are illustratively used for convenience of explanation. Therefore, the disclosure is not limited by such terms, and other terms referring to subjects having equivalent technical meanings may be used.

For convenience of explanation, the disclosure uses terms and names defined in the standards for 5G or NR and LTE systems. However, the disclosure is not limited by these terms and names, and can be equally applied to systems that comply with other standards.

That is, the communication standards specified by 3GPP will be mainly used in describing embodiments of the disclosure, but the subject matter of the disclosure can be applied to other communication systems with similar technical backgrounds with only slight modifications without significantly departing from the scope of the disclosure, and this will be possible at the discretion of a person skilled in the technical field of the disclosure.

Various phenomena caused by traffic congestion are common problems faced by large cities around the world. As a solution to this, the use of small aircraft such as helicopters for urban traffic has been considered, but commercialization has failed due to issues such as cost, noise, and safety. Recently, the implementation of urban air traffic through improved aircraft, urban air mobility (UAM), has been actively discussed, but various problems, such as the impossibility of communication support using the existing air traffic control (ATC) system implemented through the control tower due to its different form from the existing flight system, have not been resolved.

As part of a scheme to support aircraft operations requiring wireless communication through the cellular network, a method and performance for supporting communication of an unmanned aerial vehicle (UAV) using the LTE cellular system have been discussed in 3GPP. However, this discussion was targeted at low-altitude flights and assumed low-level requirements for reliability and stability of communication due to the absence of the burden of passengers on board. According to the discussion results, the technology can be supported when the demand and requirements for UAV communication are not high, but it does not guarantee adequate performance when cell traffic is high or the number of aerial UEs requiring communication is large.

As a scheme to support more improved communication performance, 3GPP discusses a method of distinguishing between an aerial UE and a terrestrial UE through NR Rel-18 and providing differentiated services for each UE. According to this discussion, the network can distinguish whether a UE requesting communication is the terrestrial UE or the aerial UE, and can apply different algorithms to the terrestrial UE and the aerial UE respectively when performing all techniques for controlling the network access of the UE, such as access control and mobility management. However, this is only a method to slightly modify the current cellular system so that it can be applied to aerial communication when an appropriate algorithm is developed in the future, and is not a discussion on a method to bring about actual performance improvement to aerial communication.

The disclosure is a study on a technique capable of more practical performance improvement in supporting UAM communication via a cellular network, and proposes, as a solution, a signaling technique that enables different cell deployments for the terrestrial UE and the aerial UE operating in the same area.

Since the UAM frequently flies at relatively higher altitudes than the existing UAV and needs higher service reliability, the cellular UAM requires clearly improved link quality compared to the existing cellular UAV. To meet this, the network access through a main lobe, not a side lobe, must be supported, and technology is needed to reduce interference received by aerial UEs in DL.

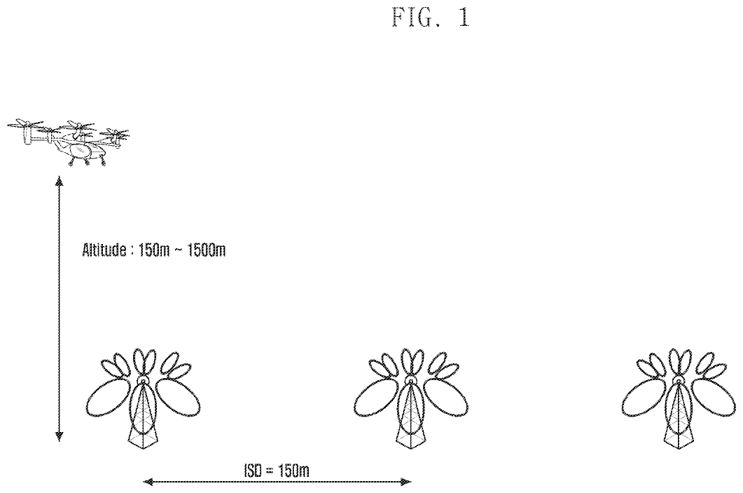

FIG. 1 is a diagram illustrating an overview of a cellular UAM network communicating through a side lobe of an existing cellular network.

FIG. 1 shows an example of applying an existing technique to support communication via a cellular network for a UAM vehicle or aerial UE flying in a microcell deployment area corresponding to a densely trafficked area. The UAM vehicle or aerial UE flying in a densely populated area needs to fly at a relatively high altitude considering noise and safety issues. In this case, the UAM vehicle or aerial UE performs communication with a large propagation loss and a small beam gain compared to a terrestrial UE As a scheme to support the aerial UE through the main lobe, 3D beam forming or vertical beam steering can be considered. However, if a base station that already performs horizontal domain beam forming or horizontal beam steering to support the terrestrial UE additionally performs vertical beam steering, the operational complexity and RS overhead of the base station may significantly increase depending on the range of vertical angles that the base station must cover. This may ultimately cause a deterioration in the existing terrestrial UE communication performance and an increase in the cost of cellular UAM communication.

In addition, in order to reduce inter-cell interference received by the aerial UE, a method for reducing the number of interference sources is needed, and a method for reducing interference sources of the aerial UE without reducing radio resources used for terrestrial UE communications is needed.

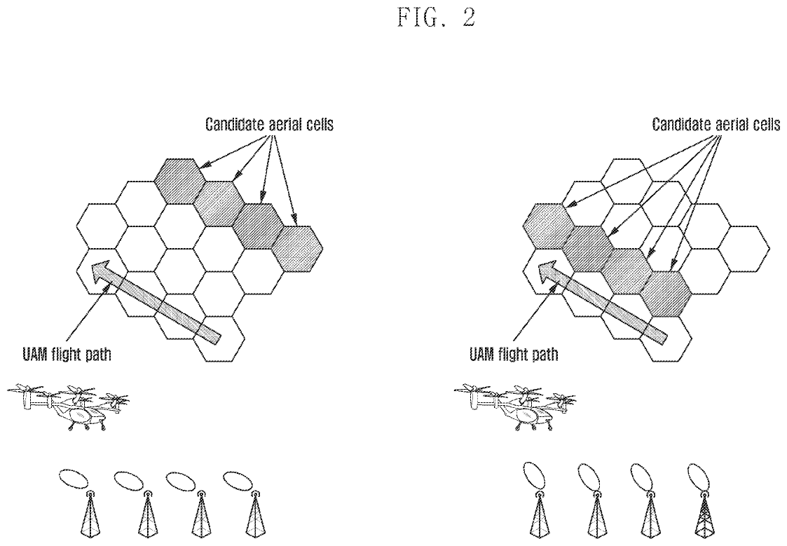

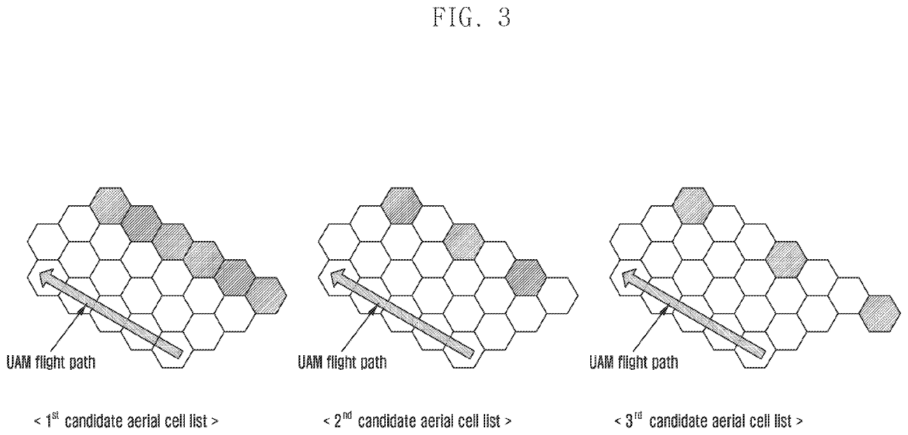

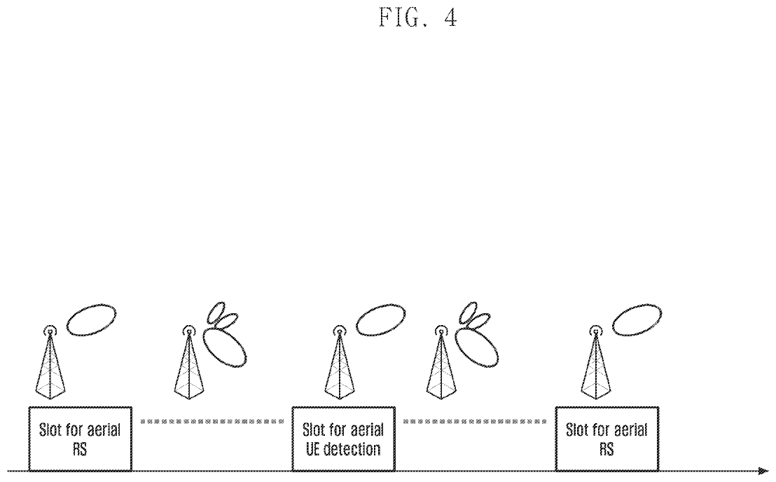

As a scheme of satisfying the above requirements, the disclosure proposes the operations of a network, especially each base station or central/local controller, and the operations of a terminal. In the following description, the operations performed by the network may be performed independently by each base station supporting the aerial UE, may be performed by a local controller managing the mobility of the aerial UE, or may be performed by a central controller managing the network supporting the aerial UE. Also, in the following description, the operations performed by the terminal may be operations performed by the aerial UE.
1. In the first step, the aerial UE (UAM UE) receives a cell identification signal or cell selection signal, e.g., SSB, transmitted to support the terrestrial UE, and can report a cell list measured through this to the network. At this time, the aerial UE can also report location information including altitude information to the network.
   The operation of the first step may be performed in the same manner as neighboring cell detection performed by the existing terrestrial UE. For example, the aerial UE can detect one or more cells, other than the serving cell, that are expected to provide similar performance to the serving cell by measuring a cell identification signal or a cell selection signal (e.g., SSB, etc.), and report the ID of the detected cell to the serving cell or the base station in charge of the serving cell. This report may be a report corresponding to mobility management.
   The operation of the first step may also be performed by measuring and reporting the optimal ‘n’ cells. In this case, the value of ‘n’ may be configured by the network or determined as an arbitrary value according to the performance of the UE. If the aerial UE is configured to perform the first step reporting operation for ‘n’ cells, the aerial UE performs reporting for a maximum of ‘n’ cells and may report ‘n’ or fewer cells.
2. In the second step, the network can generate a first candidate aerial cell list that the aerial UE should measure, based on the cell list reported by the aerial UE, and notify the first candidate aerial cell list to the UE.
   As a scheme of generating the first candidate aerial cell list, the network may generate the first candidate aerial cell list by selecting cells that are commonly reported from among the cell lists reported by adjacent aerial UEs.
   As another scheme of generating the first candidate aerial cell list, the network may generate the first candidate aerial cell list, based on the location information of each base station, the vertical beam steering information that each base station can support, and the altitude and location information of the aerial UE. To this end, all or some of the location information of the base station, the vertical beam steering information that each base station can support, and the altitude and location information of the aerial UE may be shared between base stations forming the network or between the base station and the main controller.
   As still another scheme of generating the first candidate aerial cell list, the network may mix the above two schemes.
   FIG. 2 is a diagram illustrating a scheme of composing a candidate aerial cell list according to an embodiment of the disclosure. With reference to FIG. 2, examples are shown for a case of composing the first candidate aerial cell list through base stations supporting low-angle vertical beam steering and for a case of composing the first candidate aerial cell list through base stations supporting relatively high-angle vertical beam steering.
   The operation of the second step may be performed independently at each base station supporting the aerial UE, performed by a local controller that manages the mobility of the aerial UE, or performed by a central controller that manages the network supporting the aerial UE. In the case where each cell or each base station supporting the aerial UE communication is in charge of a wide aerial coverage, each base station or each cell may be configured to simply support the second step operation without information exchanging and interworking between network entities. Alternatively, in the case where the travel radius of the aerial UE is very wide compared to the cell coverage and thus the aerial UE mobility support through inter-cell or inter-base station interconnection is required, the second step operation may be performed in such a way that the cell list reported by each aerial UE to the serving cell in the first step operation is shared between base stations and between the base station and the controller, and the controller analyzes the list and notifies the result to each base station or cell.
3. In the third step, the UE can measure the link performance information expected when performing cell selection based on the first candidate aerial cell list, and report it to the network.
   The above report is intended to report information for the network to determine whether the first candidate aerial cell list is a combination of cells suitable for supporting cellular UAM communication. Therefore, for this purpose, information capable of expressing the link performance expected when performing aerial communication using only cells included in the first candidate aerial cell list can be reported.
   As an example of a method for performing the above measurement and reporting, the UE may periodically report the link performance information, and at each report time, the UE may select ‘n’ optimal cells from the first candidate aerial cell list and then report information on the ‘n’ optimal cells and DL-RSRP or DL-SINR measured in RS of the ‘n’ optimal cells. In addition, the UE may receive the value of ‘n’ from the base station.
   When performing the reporting of the third step, the aerial UE may report the measurement value to the serving cell or the base station in charge of the serving cell. Depending on the aerial network organizing scheme, each serving cell or the base station in charge of the serving cell may send the above-mentioned report to the local controller or central controller managing the aerial UE.
In performing the second and third steps, a configuring, notifying, measuring or reporting operation based on a plurality of candidate aerial cell lists may be performed. For example, operations of configuring, notifying, measuring and reporting information related to a plurality of candidate aerial cell lists, such as the second candidate aerial cell list, the third candidate aerial cell list, etc., together with the first candidate aerial cell list, may be performed. When the operations based on the plurality of candidate aerial cell lists are performed, the UE's measuring and reporting may be performed for each candidate aerial cell list. In addition, each of the plurality of candidate aerial cell lists may be generated by the same or different methods among the plurality of methods for generating the candidate aerial cell list described in the second step, or may also be generated by other methods. FIG. 3 is a diagram illustrating an example of composing a plurality of candidate aerial cell lists according to an embodiment of the disclosure. With reference to FIG. 3, it is possible to configure cells included in the plurality of candidate aerial cell lists to overlap with each other or to configure one list to be a subset of another list. Through such configurations and UE's reporting according to the configurations, the network can obtain information on combinations that can support aerial communications while allowing a smaller number of base stations/cells to perform vertical beam steering.
4. In the fourth step, based on the UE's report according to the third step and additional information, the network can generate an aerial cell list composed of base stations or cells that will perform vertical beam steering to support the aerial UE.
   In selecting the aerial cell list, the network may generate the aerial cell list in the following various ways.
i. Generate the aerial cell list per aerial UE or per UAM vehicle
ii. Generate the aerial cell list per UAM vehicle group that follows a certain flight path or per flight path
iii. Generate the aerial cell list per region to be applied to support all aerial UEs in a certain region
   In addition, when the plurality of candidate aerial cell lists are configured, the network may generate the aerial cell list by selecting one or some of the plurality of candidate cell lists.
   In the case where the central controller or the local controller is installed to manage the aerial UE communication or the interconnection operations between multiple cells or base stations, such as access control or mobility management during the aerial UE communication, the fourth step operation is determined by the central controller or the local controller, and the central controller or the local controller can notify the result to the corresponding cell or base station so that aerial UE support is performed by the corresponding cell or base station. In another implementation of the aerial UE cellular network, if each cell or base station is configured to support wide aerial coverage, whether or not to support the aerial UE for each cell or base station in the fourth step may be determined independently by each cell or base station or determined through cooperation between a small number of adjacent cells or base stations without a common controller.
5. In the fifth step, based on the aerial cell list, the network can enable some base stations to perform the vertical beam steering operation. In addition, the network may notify the aerial cell list generated in the fourth step to the aerial UE.
   As part of the aerial communication operation performed by a cell selected as an aerial cell that performs the vertical beam steering operation, the cell or base station may perform the following operations.
i. The cell or base station may set a vertical beam to be used for the aerial communication and then, based on the vertical beam, perform transmission and reception of signals targeting the aerial UE.
ii. The cell or base station may perform transmission of an RS signal necessary for determining whether the aerial UE can communicate with the cell or base station through the main lobe. In an example of the RS signal transmission, the cell or base station may perform CSI-RS signal transmission using an electrically up-tilted beam.
iii. The cell or base station may transmit, to the aerial UE through the vertical beam, information necessary for the aerial UE to access the cell or information necessary for making a handover request.
   The following schemes may be used when the network selects the base station or cell to perform the vertical beam steering.
i. The network or base station/cell may be configured to always perform the vertical beam steering regardless of whether there is the aerial UE that has accessed the corresponding cell.
ii. The network or base station/cell may be configured to perform the vertical beam steering at a certain rate regardless of whether there is the aerial UE that has accessed the corresponding cell.
iii. The network or base station/cell may be configured to perform the vertical beam steering only when there is the aerial UE that has accessed the corresponding cell.
iv. The network or base station/cell may perform detailed configuration of the vertical beam steering for each base station/cell, such as the frequency of performing the vertical beam steering, by considering the presence of the aerial UE that has accessed the corresponding cell, the amount of radio resources required for communication of the terrestrial UE that has accessed the corresponding cell, etc.
   The use of a vertical steering beam for aerial UE support or a regular beam for terrestrial UE support can be dynamically switched based on the base station scheduling determination for each slot. FIG. 4 is a diagram illustrating an example of using a vertical beam of an aerial cell not accessed by an aerial UE according to an embodiment of the disclosure. With reference to FIG. 4, the aerial cell transmits an aerial cell detection/selection RS through a vertical beam in a specific cycle to support cell detection of the aerial UE, and may also attempt to receive an access request through a vertical beam in an interval where the reception of an access request from an aerial UE is expected. In an interval where transmission through the vertical beam is not performed, the aerial cell may perform the existing operations for supporting the terrestrial UE.
   The following schemes may be used for the network to notify the aerial cell list to the aerial UE.
i. The network may transmit all or part of the aerial cell list to each aerial UE via a UE specific signal. As an example of the UE specific signal, the network may transmit all or part of the aerial cell list to each aerial UE via RRC configuration.
ii. The network may transmit the aerial cell list to the aerial UE via broadcasting of each base station or cell corresponding to the aerial cell list.
6. In the sixth step, the UE selects one or more cells from the aerial cell list received in the fifth step to perform cell access, and if a handover operation is required, the UE may select another cell from the aerial cell list to perform a handover or request the network to perform a handover.
   The aerial UE may be prohibited from accessing a cell not included in the aerial cell list, or may be prohibited from requesting access to a cell not included in the aerial cell list.
   The aerial UE may be configured or indicated not to perform a detection operation for a cell not included in the received aerial cell list.

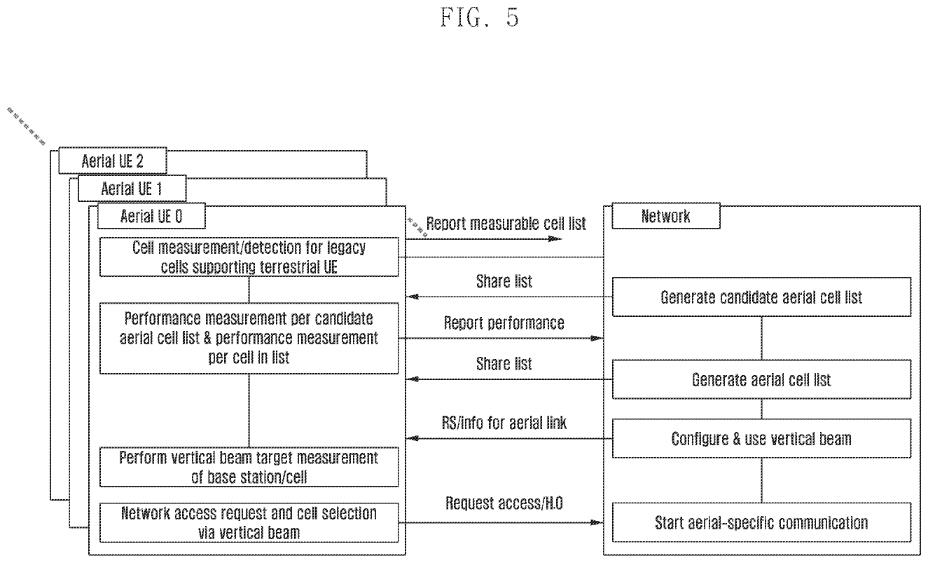

FIG. 5 is a diagram illustrating the operations of a UE and a network according to an embodiment of the disclosure.

With reference to FIG. 5, an aerial UE receives a cell identification signal or a cell selection signal, such as SSB, transmitted to support a terrestrial UE, and can report a measurable cell list, measured through this, to the network.

The network that receives the cell list from the aerial UE can generate, based on the cell list reported by the aerial UE, a candidate aerial cell list indicating a list of cells that the aerial UE should measure. The network can notify the generated candidate aerial cell list to the aerial UE. At this time, the generated candidate aerial cell list may be one or plural, and when a plurality of candidate aerial cell lists are used, each candidate aerial cell list may be generated in the same or different ways.

Based on the one or more candidate aerial cell lists received from the network, the aerial UE can measure link performance expected when performing cell selection for each candidate aerial cell list or each cell. In addition, the aerial UE can report information on the measured link performance to the network.

Based on the link performance information received from the aerial UE, the network can generate an aerial cell list composed of base stations or cells that will perform vertical beam steering to support the aerial UE. In addition, the network can enable the base station determined to perform the vertical beam steering to perform the vertical beam steering operation for supporting the aerial UE. In addition, the network can notify the aerial cell list generated based on the link performance information to the aerial UE. The UE can perform vertical beam target measurement using one or more cells in the aerial cell list received from the network and, based on this, perform aerial communication operations such as cell access or handover.

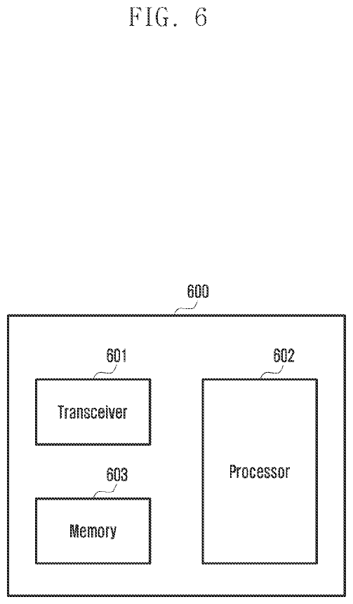

FIG. 6 is a diagram illustrating the structure of a UE according to an embodiment of the disclosure.

With reference to FIG. 6, the UE 600 may include a transceiver 601, a controller (processor) 602, and a storage (memory) 603. However, the components of the UE 600 are not limited to the above example. According to other embodiments, the UE 600 may include more or fewer components than the above-mentioned components. In certain cases, the transceiver 601, the controller 602, and the storage 603 may be implemented in the form of a single chip.

The transceiver 601 may be composed of a transmitter and a receiver in another embodiment. The transceiver 601 may transmit and receive signals to and from a base station. These signals may include control information and data. To this end, the transceiver 601 may include a radio frequency (RF) transmitter that up-converts and amplifies the frequency of an outgoing signal, an RF receiver that low-noise amplifies an incoming signal and down-converts the frequency, etc. In addition, the transceiver 601 may receive a signal through a radio channel and output it to the controller 602, and may transmit a signal output from the controller 602 through the radio channel.

The controller 602 may control a series of processes by which the UE 600 can operate according to the above-described embodiment of the disclosure. To this end, the controller 602 may include at least one processor. For example, the controller 602 may include a communication processor (CP) that performs control for communication, and an application processor (AP) that controls upper layers such as application programs. The storage 603 may have a region for storing data necessary for the control of the controller 602 and data generated during the control of the controller 602.

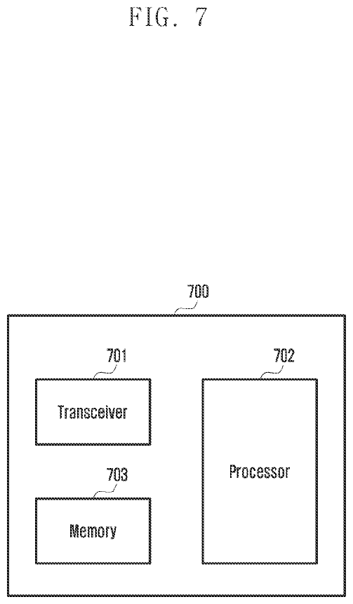

FIG. 7 is a diagram illustrating the structure of a base station according to an embodiment of the disclosure.

With reference to FIG. 7, the base station 700 may include a transceiver 701, a controller (processor) 702, and a storage (memory) 703. However, the components of the base station 700 according to one embodiment are not limited to the above example. According to other embodiments, the base station 700 may include more or fewer components than the above-mentioned components. In certain cases, the transceiver 701, the controller 702, and the storage 703 may be implemented in the form of a single chip. The transceiver 701 may be composed of a transmitter and a receiver in another embodiment. The transceiver 701 may transmit and receive signals to and from a UE. These signals may include control information and data. To this end, the transceiver 701 may include an RF transmitter that up-converts and amplifies the frequency of an outgoing signal, an RF receiver that low-noise amplifies an incoming signal and down-converts the frequency, etc. In addition, the transceiver 701 may receive a signal through a radio channel and output it to the controller 702, and may transmit a signal output from the controller 702 through the radio channel.

The controller 702 may control a series of processes by which the base station 700 can operate according to the above-described embodiment of the disclosure. To this end, the controller 702 may include at least one processor. For example, the controller 702 may include a communication processor (CP) that performs control for communication, and an application processor (AP) that controls upper layers such as application programs. The storage 703 may have a region for storing data necessary for the control of the controller 702 and data generated during the control of the controller 702.

In the specific embodiments of the disclosure described above, components included in the disclosure are expressed in the singular or the plural according to the presented specific embodiments. However, the singular or plural expression is appropriately selected for the presented situation for convenience of description, and the disclosure is not limited to the singular or plural components, and even if the component is expressed in the plural, the component may be configured with the singular, or even if the component is expressed in the singular, the component may be configured with the plural.

Meanwhile, the embodiments disclosed in this specification and drawings are only specific examples to easily explain the technical contents of the disclosure and to help the understanding of the disclosure, and are not intended to limit the scope of the disclosure. That is, it is obvious to a person having ordinary skill in the art to which the disclosure pertains that other modified examples based on the technical idea of the disclosure are possible. In addition, the respective embodiments may be combined and operated with each other as needed. For example, parts of one embodiment of the disclosure and another embodiment may be combined with each other. In addition, the embodiments may be implemented with other modified examples based on the technical idea of the above-described embodiments in other systems, for example, an LTE system, a 5G or NR system, etc.

1. A method performed by a terminal in a communication system, the method comprising:
reporting a cell list measurable by the terminal to a network;
receiving, from the network, a candidate aerial cell list generated based on the measurable cell list and indicating a list of candidate cells to be measured by the terminal;
reporting link performance measured for cells in the candidate aerial cell list to the network;
receiving an aerial cell list generated based on the link performance and indicating a list of cells to perform vertical beam steering; and
performing aerial communication based on cells included in the aerial cell list.

2. The method of claim 1, wherein the candidate aerial cell list is generated based on commonly reported cells in the measurable cell lists reported from a plurality of terminals.

3. The method of claim 1, wherein the candidate aerial cell list is generated based on location information, including altitude information, of the terminal, location information of a base station, and vertical beam steering information supportable by the base station.

4. The method of claim 1, wherein the aerial cell list is generated per terminal, per terminal's flight path, or per region.

5. The method of claim 1, wherein receiving the candidate aerial cell list from the network includes receiving a plurality of candidate aerial cell lists from the network.

6. The method of claim 5, wherein the aerial cell list is generated based on any one of the plurality of candidate aerial cell lists.

7. The method of claim 1, wherein access and cell detection are not performed for cells not included in the aerial cell list.

8. A terminal in a wireless communication system, the terminal comprising:
a transceiver; and
a controller configured to:
report a cell list measurable by the terminal to a network,
receive, from the network, a candidate aerial cell list generated based on the measurable cell list and indicating a list of candidate cells to be measured by the terminal,
report link performance measured for cells in the candidate aerial cell list to the network,
receive an aerial cell list generated based on the link performance and indicating a list of cells to perform vertical beam steering, and
perform aerial communication based on cells included in the aerial cell list.

9. The terminal of claim 8, wherein the candidate aerial cell list is generated based on commonly reported cells in the measurable cell lists reported from a plurality of terminals.

10. The terminal of claim 8, wherein the candidate aerial cell list is generated based on location information, including altitude information, of the terminal, location information of a base station, and vertical beam steering information supportable by the base station.

11. The terminal of claim 8, wherein the aerial cell list is generated per terminal, per terminal's flight path, or per region.

12. The terminal of claim 8, wherein the controller is configured to receive a plurality of candidate aerial cell lists from the network, and
the aerial cell list is generated based on any one of the plurality of candidate aerial cell lists.

13. The terminal of claim 8, wherein access and cell detection are not performed for cells not included in the aerial cell list.

14. A method performed by a base station in a communication system, the method comprising:
receiving a cell list measurable by a terminal;
generating a candidate aerial cell list indicating a list of candidate cells to be measured by the terminal, based on the measurable cell list;
transmitting the candidate aerial cell list to the terminal;
receiving link performance measured for cells in the candidate aerial cell list;
generating an aerial cell list indicating a list of cells to perform vertical beam steering, based on the link performance; and
transmitting the candidate aerial cell list to the terminal.

15. A base station in a communication system, the base station comprising:
a controller configured to:
receive a cell list measurable by a terminal,
generate a candidate aerial cell list indicating a list of candidate cells to be measured by the terminal, based on the measurable cell list,
transmit the candidate aerial cell list to the terminal,
receive link performance measured for cells in the candidate aerial cell list,
generate an aerial cell list indicating a list of cells to perform vertical beam steering, based on the link performance, and
transmit the candidate aerial cell list to the terminal.
